(19) United States
(12) Patent Application Publication
(10) Pub. No.: US 2014/0123927 A1
(43) Pub. Date: May 8, 2014

(54) INTAKE PLENUM PRESSURE RELEASE VALVE

(71) Applicant: Speed of Air, Inc., Reno, NV (US)

(72) Inventors: Joey A. Malfa, Reno, NV (US); Bobby Joe Jones, II, San Angelo, TX (US)

(73) Assignee: Speed of Air, Inc., Reno, NV (US)

(21) Appl. No.: 14/071,347

(22) Filed: Nov. 4, 2013

Related U.S. Application Data
(60) Provisional application No. 61/722,066, filed on Nov. 2, 2012.

(51) Int. Cl. F02M 35/10

(52) U.S. Cl. CPC F02M 35/10255
USPC 123/188.14

(57) ABSTRACT

A pressure release valve configured to vent excess pressure from an intake manifold. The pressure release valve includes a sealing surface on the intake manifold, a top plate coupled to and spaced from the sealing surface, and a seal plate slidably disposed between the top plate and the sealing surface. The seal plate is configured to move between a closed position and an open position when subject to a pressure exceeding a threshold pressure. The pressure release valve also includes at least one resilient member disposed between the sealing surface and the top plate. The at least one resilient member is adapted to bias the seal plate into the closed position.

### CROSS-REFERENCE TO RELATED APPLICATION

This application claims the benefit of and priority to U.S. Provisional Application Ser. No. 61/722,066, filed Nov. 2, 2012, the entire contents of which are hereby incorporated by reference.

### FIELD

The present invention relates generally to internal combustion engines, and, more particularly, to pressure relief valves.

### BACKGROUND

Internal combustion engines commonly include an intake manifold configured to distribute a mixture of air and fuel evenly to the cylinders. The fuel and air mixture in the intake manifold is susceptible to being ignited by a flame generated during the combustion process of the engine. Additionally, the fuel and air mixture in the intake manifold is susceptible to ignition by an ignition spark entering the intake manifold during the engine startup process. If the fuel and air mixture in the intake manifold ignites due to a back fire, the internal pressure in the intake manifold may increase as high as 400 pounds per square inch (“psi”), which can damage various internal components of the engine if there is no avenue for the pressure to vent externally.

Accordingly, conventional engines incorporate a burst seal or membrane valve configured to rupture when the internal pressure in the intake manifold exceeds a threshold pressure. However, such burst seals and membrane valves are only suitable for a single use and must be replaced after each engine back fire incident. Replacing the burst seals or membrane valves after each engine back fire incident is both cumbersome and costly. Additionally, the downtime of the engine during replacement of the burst seals or membrane valves adds to the cost.

### SUMMARY

The present disclosure is directed to various embodiments of a pressure release valve configured to be coupled to an intake manifold of an internal combustion engine. In one embodiment, the pressure release valve includes a sealing surface on the intake manifold, a top plate coupled to and spaced from the sealing surface, and a seal plate slidably disposed between the top plate and the sealing surface. The seal plate is configured to move between a closed position and an open position when subject to a pressure exceeding a threshold pressure. The pressure release valve also includes at least one resilient member disposed between the sealing surface and the top plate. The resilient member is adapted to bias the seal plate into the closed position.

The pressure release valve may also include a base plate coupled to the top plate. The pressure release valve may also include a spark arrestor coupled to the sealing surface. In one embodiment, the spark arrestor is rotated approximately 45 degrees relative to the seal plate such that fasteners coupling the spark arrestor to the sealing surface are accessible. In one embodiment, the threshold pressure required to move the seal plate into the open position is from approximately 60 psi to approximately 100 psi. In one embodiment, the resilient member includes a series of springs. In one embodiment, the pressure release valve includes a series of guide pins extending between the sealing surface and the top plate. The seal plate is configured to slide along the guide pins between the open position and the closed position. In one embodiment, the resilient member includes a series of springs on the guide pins. In one embodiment, the pressure release valve also includes an outer gasket having the sealing surface. In another embodiment, the pressure release valve further includes an inner gasket between the spark arrestor and the sealing surface.

The present disclosure is also directed to a pressure release valve including a sealing surface on the intake manifold, a top plate coupled to and spaced from the sealing surface, a seal plate slidably disposed between the top plate and the sealing surface, and a plurality of guide pins extending between the sealing surface and the top plate. The seal plate is configured to slide along the plurality of guide pins between a closed position and an open position when subject to a pressure exceeding a threshold pressure. The pressure release valve also includes a series of springs disposed between the sealing surface and the top plate. The springs are adapted to bias the seal plate into the closed position.

In one embodiment, the pressure release valve may include a spark arrestor coupled to the sealing surface. The pressure release valve may also include a base plate coupled to the top plate. In one embodiment, the top plate includes a series of notches and the base plate includes a series of notches aligned with the notches in the top plate. In one embodiment, the pressure release valve also includes an outer gasket having the sealing surface. In one embodiment, the pressure release valve includes a series of fasteners configured to couple the sealing surface to the intake manifold. The fasteners may be angularly offset from the guide pins such that the fasteners are accessible for installation and removal.

The present disclosure is also directed to a pressure release valve a base plate configured to be coupled to an intake manifold, a top plate coupled to and spaced from the base plate, and a seal plate slidably disposed between the top plate and the base plate. The seal plate is configured to move between a closed position and an open position when subject to a pressure exceeding a threshold pressure. The pressure release valve also includes at least one resilient member disposed between the base plate and the top plate. The resilient member is adapted to bias the seal plate into the closed position. In one embodiment, the pressure release valve may include a spark arrestor coupled to the base plate. In one embodiment, the at least one resilient member may be a series of springs. In one embodiment, the base plate may be coupled to a first end of the intake manifold.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a top perspective view of a pressure release valve according to one embodiment of the present disclosure;

FIG. 2 is a bottom perspective view of the pressure release valve of FIG. 1;

FIG. 3 is an exploded perspective view of the pressure release valve of FIG. 1;

FIG. 4 is a top view of the pressure release valve of FIG. 1; and

FIGS. 5A and 5B are cross-sectional views of the pressure release valve of FIG. 1 in a closed position and an open position, respectively.

### DETAILED DESCRIPTION

The present disclosure is directed to various embodiments of a pressure release valve configured to be coupled to an intake manifold of an internal combustion engine. The pressure release valves of the present disclosure are configured to vent a buildup of excess pressure in the intake manifold, which may be caused by an ignition of the air and fuel mixture in the intake manifold. Otherwise, such excess pressure in the intake manifold may damage various components of the engine, such as valves, springs, and turbo chargers. Additionally, the pressure release valves of the present disclosure are configured to prevent the spread of a fire into the intake manifold, which might otherwise cause an external fire.

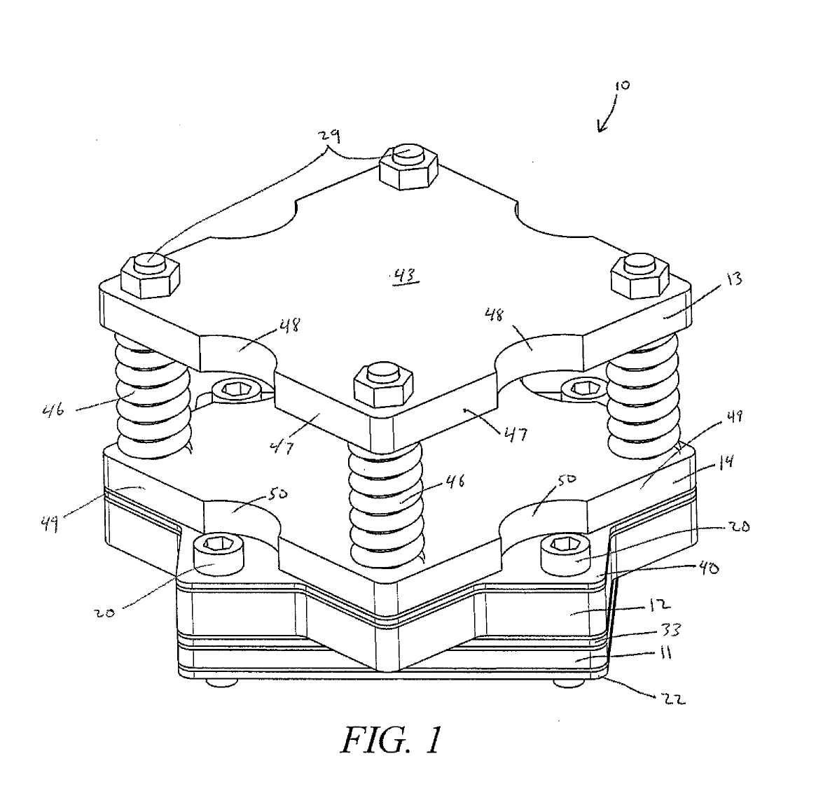

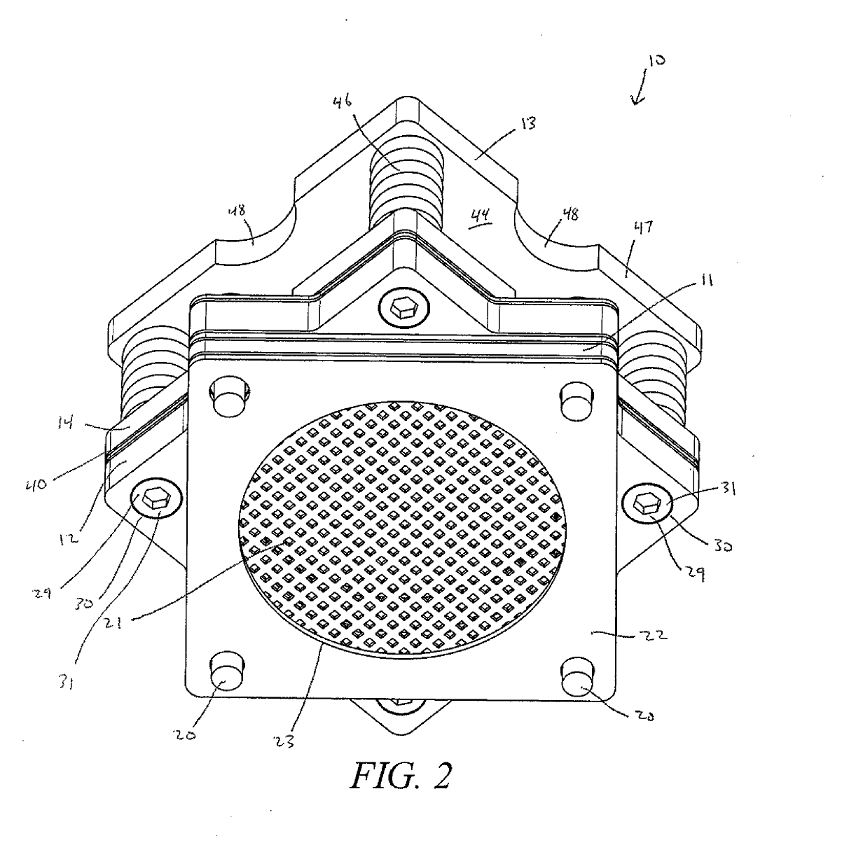

With reference now to the embodiment illustrated in FIGS. 1 and 2, the pressure release valve 10 includes a spark arrestor 11, a base plate 12 coupled to the spark arrestor 11, a top plate 13, and a seal plate 14 slidably disposed between the top plate 13 and the base plate 12. As described in more detail below, the seal plate 14 is configured to slide between a closed, sealed position and an open, vented position. In the open, vented position, the pressure release valve 10 is configured to vent the gaseous mixture in the intake manifold when the internal pressure in the intake manifold exceeds a threshold pressure. Additionally, the pressure release valve 10 is configured to return to the closed, sealed position after a sufficient amount of the gaseous mixture has vented to the atmosphere such that the internal pressure in the intake manifold drops below the threshold pressure.

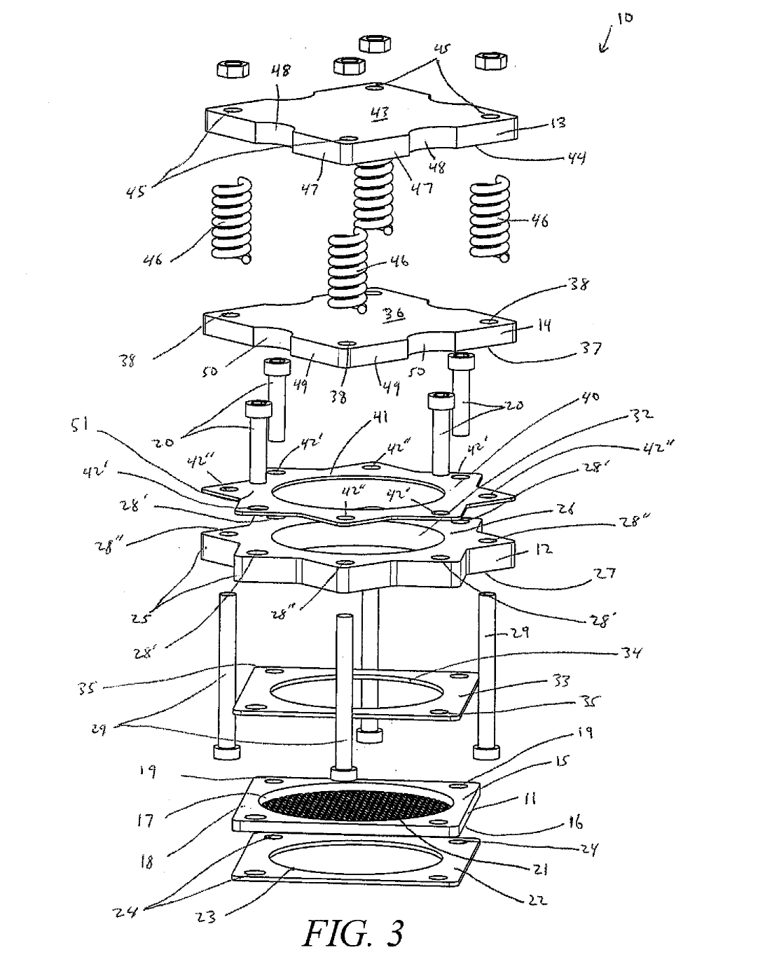

With reference now to the embodiment illustrated in FIG. 3, the spark arrestor 11 is a rectangular plate having an outer surface 15 and an inner surface 16 opposite the outer surface 15. Although the spark arrestor 11 in the illustrated embodiment is rectangular, in one or more alternate embodiments, the spark arrestor 11 may have any other suitable shape, such as, for instance, circular, and still fall within the scope and spirit of the present disclosure. The spark arrestor 11 also includes a central opening 17 and a flange 18 extending around a periphery of the central opening 17. In the illustrated embodiment, the flange 18 defines a plurality of openings 19 (e.g., smooth bore through holes) configured to receive fasteners 20 coupling the spark arrestor 11 to the intake manifold. Although in the illustrated embodiment, the flange 18 of the spark arrestor 11 defines four openings 19, in one or more other embodiments, the flange 18 may define any other suitable number of openings 19, such as, for instance, from two to ten openings 19, depending on the number of fasteners 20 coupling the spark arrestor 11 to the intake manifold.

The central opening 17 in the spark arrestor 11 is configured to align with an opening in the intake manifold so that when the internal pressure in the intake manifold exceeds a threshold pressure, such as due to an ignition of the air and fuel mixture in the intake manifold, the gaseous mixture in the intake manifold may vent through the aligned openings in the intake manifold and the spark arrestor 11. The central opening 17 in the spark arrestor 11 may have any suitable diameter sufficient to rapidly vent the gaseous mixture in the intake manifold, such as, for instance, between approximately 2 inches and approximately 6 inches. Additionally, although the central opening 17 in the illustrated embodiment is circular, the central opening 17 may have any other suitable shape, such as, for instance, square, and still fall within the scope and spirit of the present disclosure.

As illustrated in FIGS. 2 and 3, the spark arrestor 11 also includes a mesh screen 21 covering the central opening 17. The mesh screen 21 is configured to prevent flammable debris from escaping the intake manifold (i.e., the mesh screen 21 of the spark arrestor 11 is configured to contain any flammable debris within the intake manifold). Otherwise, flammable material escaping the intake manifold may cause an external fire.

Still referring to the embodiment illustrated in FIG. 3, the pressure release valve 10 also includes an inner gasket 22 disposed between the spark arrestor 11 and the intake manifold. The inner gasket 22 is configured to abut the inner surface 16 of the spark arrestor 11 and an outer surface of the intake manifold. The inner gasket 22 defines a central opening 23 configured to align with the central opening 17 in the spark arrestor 11 and the opening in the intake manifold. The inner gasket 22 also defines a plurality of openings 24 configured to align with the openings 19 in the spark arrestor 11. The openings 24 in the inner gasket 22 are configured to receive the fasteners 20 coupling the base plate 12 and the spark arrestor 11 to the intake manifold. When the fasteners 20 are installed, the spark arrestor 11 is drawn toward the intake manifold, thereby compressing the inner gasket 22 to create a fluid-tight seal between the spark arrestor 11 and the intake manifold. In the illustrated embodiment, the inner gasket 22 is rectangular and substantially matches the shape of the spark arrestor 11. In one or more alternate embodiments, the inner gasket 22 may have any other suitable shape, such as, for instance, circular, and may not match the shape of the spark arrestor 11.

With continued reference to the embodiment illustrated in FIG. 3, the base plate 12 is an eight-point 25 star-shaped plate having an outer surface 26 and an inner surface 27 opposite the outer surface 26. Each of the eight points 25 defines an opening 28 (e.g., a smooth bore hole) extending between the outer and inner surfaces 26, 27, respectively. In the illustrated embodiment, four of the openings 28′ are configured to receive the fasteners 20 coupling the base plate 12 to the spark arrestor 11 and the intake manifold, and the other four openings 28″ are configured to receive guide pins 29 which couple the base plate 12 to the top plate 13 while providing guides upon which the seal plate 14 may slide. In one embodiment, the guide pins 29 may be shoulder cap bolts, with the shoulders of the shoulder cap bolts acting as the guides for the seal plate 14. The fasteners 20 coupling the base plate 12 to the spark arrestor 11 extend down through the four openings 28′ in the base plate 12, through the openings 24, 19 in the inner gasket 22 and the spark arrestor 11, respectively, and into the intake manifold. The guide pins 29 coupling the base plate 12 to the top plate 13 extend up through the base plate 12, the seal plate 14, and the top plate 13. The fasteners 20 may be any suitable type of fasteners, such as, for instance, socket head cap bolts or shoulder bolts. Additionally, although in the illustrated embodiment the base plate 12 is coupled to the spark arrestor 11 and the top plate 13 by four fasteners 20 and four guide pins 29, respectively, in one or more alternate embodiments, any other suitable number of fasteners 20 and guide pins 29 may be provided to couple the base plate 12 to the spark arrestor 11 and the top plate 13, respectively, such as, for instance, from two to ten fasteners 20 and from two to ten guide pins 29. In one or more alternate embodiments, the pressure release valve 10 may be provided without the base plate 12.

As illustrated in the embodiment of FIG. 2, the base plate 12 also includes a plurality of recesses 30 extending upward from the inner surface 27. The recesses 30 are concentric with the openings 28″ and configured to receive heads 31 of the guide pins 29 (e.g., shoulder bolts) coupling the base plate 12 to the top plate 13. The recesses 30 are configured such that the heads 31 of the guide pins 29 coupling the base plate 12 to the top plate 13 may be recessed in the base plate 12. For instance, the recesses 30 may be configured such that the heads 31 of the guide pins 29 do not protrude beyond the inner surface 27 of the base plate 12. Otherwise, the heads 31 of the guide pins 29 may contact the intake manifold and prevent proper installation of the pressure release valve 10. In another embodiment, the base plate 12 may be provided without the recesses 30 and the guide pins 29 may include low-profile heads 31.

The base plate 12 also defines a central opening 32 extending between the outer and inner surfaces 26, 27, respectively. The central opening 32 in the base plate 12 is configured to axially align with the central openings 17, 23 in the spark arrestor 11 and the inner gasket 22, respectively. Additionally, in the illustrated embodiment, the central opening 32 in the base plate 12 is substantially the same size and shape as the central opening 17 in the spark arrestor 11, although in one or more alternate embodiments, the central opening 32 in the base plate 12 may have a different size and/or shape than the central opening 17 in the spark arrestor 11. As described in more detail below, when the internal pressure in the intake manifold exceeds a threshold pressure, such as due to the ignition of the air and fuel mixture in the intake manifold, the gaseous mixture in the intake manifold may vent through the aligned central openings 17, 32 in the intake manifold, the spark arrestor 11, and the base plate 12.

With reference to the embodiment illustrated in FIG. 3, the pressure release valve 10 also includes an intermediate gasket 33 disposed between the spark arrestor 11 and the base plate 11. The intermediate gasket 33 is configured to abut the outer surface 15 of the spark arrestor 11 and the inner surface 27 of the base plate 12. The intermediate gasket 33 defines a central opening 34 configured to align with the central openings 17, 32 in the spark arrestor 11 and the base plate 12, respectively. The intermediate gasket 33 also defines a plurality of openings 35 configured to align with the openings 19, 28′ in the spark arrestor 11 and the base plate 12, respectively. The openings 35 in the intermediate gasket 33 are configured to receive the fasteners 20 coupling the base plate 12 and the spark arrestor 11 to the intake manifold. When the fasteners 20 are installed, the base plate 12 is drawn toward the spark arrestor 11, thereby compressing the intermediate gasket 33 to create a fluid-tight seal between the spark arrestor 11 and the base plate 12. In the illustrated embodiment, the intermediate gasket 33 is rectangular and substantially matches the shape of the spark arrestor 11. In one or more alternate embodiments, the intermediate gasket 33 may have any other suitable shape, such as, for instance, circular, and may not match the shape of the spark arrestor 11. Additionally, in one embodiment, the intermediate gasket 33 is the same or substantially the same as the inner gasket 22.

With reference again to the embodiment illustrated in FIG. 3, the seal plate 14 is a rectangular plate having an outer surface 36 and an inner surface 37 opposite the outer surface 36. The seal plate 14 defines a plurality of openings 38, such as, for instance, four openings, extending between the outer and inner surfaces 36, 37. The openings 38 in the seal plate 14 are configured to axially align with the four openings 28″ in the base plate 12. The openings 38 in the seal plate 14 are configured to receive the guide pins 29 coupling the base plate 12 to the top plate 13. In one embodiment, the openings 38 are slightly larger than the diameter of the guide pins 29 so that the seal plate 14 may slide freely along the guide pins 29 (i.e., the guide pins 29 are loose fit in the openings 38 in the seal plate 14).

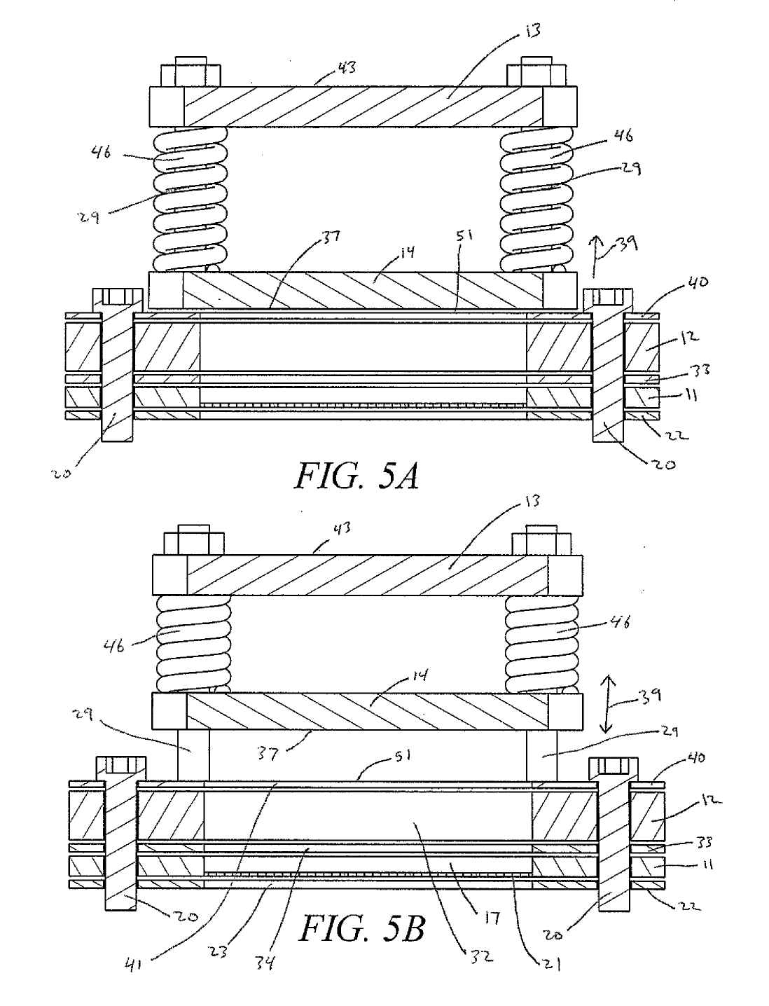

As illustrated in FIGS. 5A and 5B, the seal plate 14 is configured to slide (arrow 39) along the guide pins 29 between a closed, sealed position (FIG. 5A) and an open, vented position (FIG. 5B). In the closed, sealed position, the inner surface 37 of the seal plate 14 abuts and compresses a sealing surface 51 defined by an outer gasket 40 to form a fluid tight seal between the seal plate 14 and the base plate 12. Accordingly, in the closed, sealed position, the air and fuel mixture in the intake manifold is directed into the cylinders in the engine and cannot escape through the pressure release valve 10 (i.e., the abutment of the inner surface 37 of the seal plate 14 against the sealing surface 51 of the outer gasket 40 is configured to prevent the fuel and air mixture in the intake manifold from venting out through the pressure release valve 10). In the open, vented position, the inner surface 37 of the seal plate 14 is spaced apart from the sealing surface 51 of the outer gasket 40 such that the gaseous mixture in the intake manifold may escape between the seal plate 14 and the base plate 12 to reduce the internal pressure in the intake manifold and thereby mitigate or eliminate the potential damage to various engine components which might otherwise result from an over-pressure event in the intake manifold.

The seal plate 14 is configured to slide (arrow 39) along the guide pins 29 into the open, vented position when an internal pressure in the intake manifold exceeds a threshold pressure, such as when the air and fuel mixture in the intake manifold is ignited. In one embodiment, the seal plate 14 is configured to slide (arrow 39) into the open, vented position when the internal pressure in the intake manifold reaches from approximately 60 pounds per square inch (“psi”) to approximately 100 psi. It will be appreciated, however, that the pressure release valve 10 may be configured such that the seal plate 14 moves into the open, vented position when the internal pressure in the intake manifold reaches any other desired threshold pressure, such as, for instance, less than approximately 60 psi or greater than approximately 100 psi. Additionally, although the seal plate 14 in the illustrated embodiment is rectangular, the seal plate 14 may have any other suitable shape, such as, for instance, square or circular, and still fall within the scope and spirit of the present disclosure.

With continued reference to the embodiment illustrated in FIG. 3, the outer gasket 40 defines a central opening 41 configured to align with the central openings 17, 32 in the spark arrestor 11 and the base plate 12, respectively. The outer gasket 40 also defines a plurality of openings 42 configured to align with the openings 28 in the base plate 12. Four of the openings 42′ in the outer gasket 40 are configured to receive the fasteners 20 coupling the base plate 12 and the spark arrestor 11 to the intake manifold. The other four openings 42″ in the outer gasket 40 are configured to receive the guide pins 29 coupling the base plate 12 to the seal plate 14 and the top plate 13. When the seal plate 14 is in the closed position, the seal plate 14 is pressed against the sealing surface 51 of the outer gasket 40, thereby compressing the outer gasket 40 to create a fluid-tight seal between the base plate 12 and the seal plate 14. The fasteners coupling the base plate 12 and the spark arrestor 11 to the intake manifold are configured to maintain the outer gasket 40 in contact with the base plate 12 as the seal plate 14 moves between the closed and open positions (i.e., the outer gasket 40 is configured not to move along with the seal plate 14). In the illustrated embodiment, the outer gasket 40 is an eight-point star-shaped flat gasket that substantially matches the shape of the base plate 12. In one or more alternate embodiments, the outer gasket 40 may have any other suitable shape, such as, for instance, circular, and may not match the shape of the base plate 12.

Still referring to the embodiment illustrated in FIG. 3, the top plate 13 is a rectangular plate having an outer surface 43 and an inner surface 44 opposite the outer surface 43. The top plate 13 also includes a plurality of openings 45 extending between the outer and inner surfaces 43, 44, respectively. The openings 45 in the top plate 13 are configured to axially align with the openings 38 in the seal plate 14 and the four openings 28″ in the base plate 12. The openings 45 in the top plate 13 are configured to receive the guide pins 29 coupling the base plate 12 to the top plate 13. In one embodiment, the openings 45 are smooth bores and the guide pins 29 extend through the openings 45 and above the outer surface 43 of the top plate 13. In this embodiment, the guide pins 29 may be coupled to the top plate 13 by any suitable type of nuts, such as, for instance, self-locking hex nuts. In another embodiment, the openings 45 in the top plate 13 may be internally threaded and the guide pins 29 may be coupled to the top plate 13 by threading the guide pins 29 into the internally threaded openings 45. In one embodiment, the top plate 13 is the same or substantially the same as the seal plate 14.

With reference now to the embodiment illustrated in FIGS. 5A and 5B, the pressure release valve 10 includes a plurality of coil springs 46 disposed between the top plate 13 and the seal plate 14. The coil springs 46 are configured to bias the seal plate 14 into the closed, sealed position (FIG. 5A) and to provide a resistive force which much be overcome for the seal plate 14 to move into the open, vented position (FIG. 5B). For instance, when the internal pressure of the gaseous mixture in the intake manifold exceeds a threshold pressure, the gaseous mixture in the intake manifold is configured to pass through the opening in the intake manifold and up through the aligned central openings in the inner gasket, the spark arrestor 11, the intermediate gasket, the base plate 12, and the outer gasket, respectively, and then force the seal plate 14 to compress the coil springs 46 and slide upward along the guide pins 29 into the open, vented position. Once a sufficient amount of the gaseous mixture has vented into the atmosphere such that the internal pressure in the intake manifold drops below the threshold pressure, the biasing force of the coil springs 46 forces the seal plate 14 to slide downward along the guide pins 29 and return to the closed, sealed position.

In one embodiment, the pressure release valve 10 includes four pairs of nested springs wound around the guide pins 29 (i.e., each guide pins 29 includes an inner spring wound around the guide pins 29 and an outer spring wound around the outside of the inner spring). Nesting the inner and outer springs is configured to increase the effective spring constant of the springs 46 without significantly increasing the size of the springs 46. In one embodiment, the inner springs have a spring constant of approximately 200 psi and the outer springs have a spring constant of approximately 300 psi. It will be appreciated, however, that the springs 46 may have any other suitable combination of spring constants based upon the desired threshold pressure required to move the seal plate 14 into the open, vented position. In one embodiment, the spring constants may be selected such that the seal plate 14 moves into the open, vented position when the internal pressure in the intake manifold reaches from approximately 60 psi to approximately 100 psi. It will be appreciated, however, that the spring constants of the springs 46 may be selected such that the seal plate 14 is configured to move into the open, vented position when the internal pressure in the intake manifold reaches any other desired threshold pressure, such as, for instance, less than approximately 60 psi or greater than approximately 100 psi. In one embodiment, the pressure release valve 10 may include any other suitable types of springs, such as, for instance, wave springs, instead of, or in addition to, the coil springs 46. Additionally, in another embodiment, the pressure release valve 10 may include any other suitable type of resilient member, such as, for instance, air springs, instead of, or in addition to, the coil springs 46.

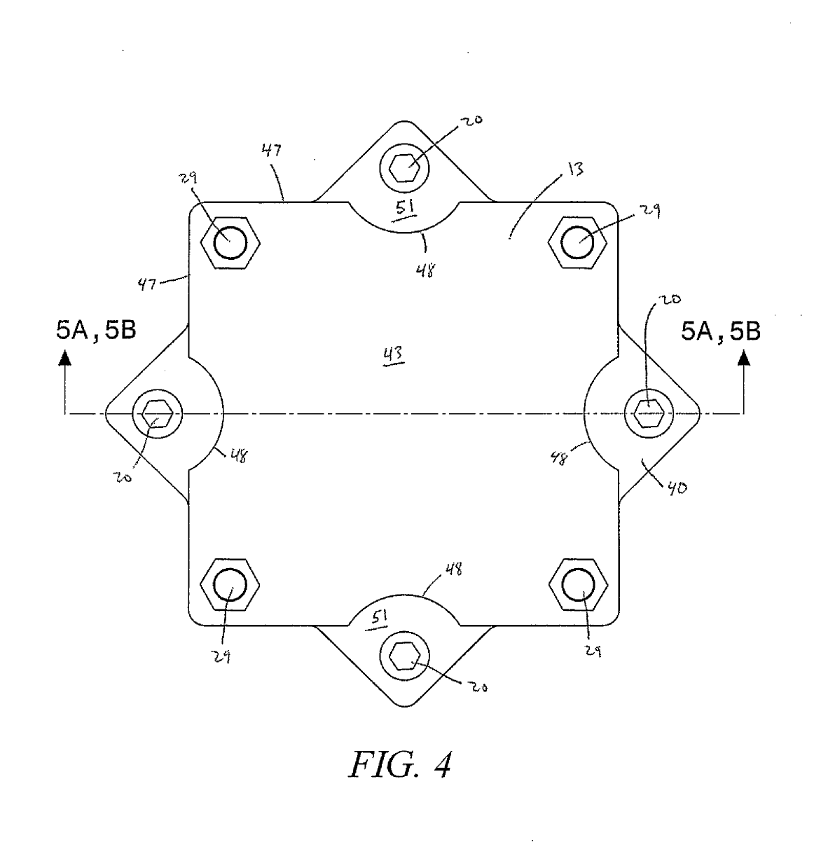

As illustrated in the embodiment of FIGS. 1 and 4, the spark arrestor 11 is oriented approximately 45 degrees relative to the seal plate 14 and the top plate 13 (i.e., the spark arrestor 11 is oriented or clocked approximately 45 degrees out of alignment with the seal plate 14 and the top plate 13). Accordingly, the fasteners 20 coupling the base plate 12 and the spark arrestor 11 to the intake manifold are exposed and accessible (i.e., the fasteners 20 coupling the base plate 12 and the spark arrestor 11 to the intake manifold are not covered by the seal plate 14). Therefore, the pressure release valve 10 may be readily attached and detached from the intake manifold by installing and removing the fasteners 20, respectively. In an alternate embodiment, the spark arrestor 11 may be aligned with the seal plate 14 and the top plate 13, and the fasteners 20 may be countersunk in the base plate 12 such that the seal plate 14 covers the fasteners 20.

With reference now to the embodiment illustrated in FIGS. 1, 3, and 4, each side 47 of the top plate 13 defines an arcuate notch 48 and each side 49 of the seal plate 14 defines an arcuate notch 50 aligned with the notches 48 in the top plate 13. The notches 48, 50 in the top plate 13 and the seal plate 14, respectively, are configured to facilitate installation and removal of the fasteners 20 coupling the base plate 12 and the spark arrestor 11 to the intake manifold. For instance, a socket extension attached to a wrench may be used to install and remove the fasteners 20. In another embodiment, the top plate 13 and the seal plate 14 may be provided without the notches 48, 50 and the base plate 12 and the spark arrestor 11 may be configured such that the fasteners 20 are sufficiently spaced apart from the sides 47, 49 of the top plate 13 and the seal plate 14, respectively, such that the fasteners 20 may be accessed, for example, by a socket extension on a wrench.

The pressure release valves 10 of the present disclosure may be installed in any type of engine susceptible to a back fire event. In one embodiment, the intake manifold includes two pressure release valves 10 installed at opposite ends of the intake manifold, although the intake manifold may include any other suitable number of pressure release valves 10 and the pressure release valves 10 may be provided at any other locations on the intake manifold.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” “vertical,” “horizontal,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a surface, plate, or other component is referred to as being “on” another surface, plate, or other component, it can be directly on the other surface, plate, or other component or intervening surfaces, plates, or components may also be present therebetween. Moreover, when a component is component is referred to as being “coupled” to another component, it can be directly attached to the other component or intervening components may be present therebetween.

What is claimed is:

1. A pressure release valve configured to vent excess pressure from an intake manifold of an internal combustion engine, the pressure release valve comprising:
a sealing surface on the intake manifold;
a top plate coupled to and spaced from the sealing surface;
a seal plate slidably disposed between the top plate and the sealing surface, wherein the seal plate is configured to move between a closed position and an open position when subject to a pressure exceeding a threshold pressure; and
at least one resilient member disposed between the sealing surface and the top plate and adapted to bias the seal plate into the closed position.

2. The pressure release valve of claim 1, wherein the sealing surface is on a base plate coupled to the intake manifold.

3. The pressure release valve of claim 1, wherein the threshold pressure is from approximately 60 psi to approximately 100 psi.

4. The pressure release valve of claim 1, further comprising a spark arrestor coupled to the sealing surface.

5. The pressure release valve of claim 1, wherein the at least one resilient member comprises a plurality of springs.

6. The pressure release valve of claim 1, further comprising an outer gasket defining the sealing surface.

7. The pressure release valve of claim 4, wherein the spark arrestor is rotated approximately 45 degrees relative to the seal plate such that fasteners coupling the spark arrestor to the sealing surface are accessible.

8. The pressure release valve of claim 1, further comprising:
a plurality of guide pins extending between the sealing surface and the top plate, wherein the seal plate is configured to slide along the guide pins between the open position and the closed position; and
wherein the at least one resilient member comprises a plurality of springs on the guide pins.

9. A pressure release valve configured to vent excess pressure from an intake manifold of an internal combustion engine, the pressure release valve comprising:
a sealing surface on the intake manifold;
a top plate coupled to and spaced from the sealing surface;
a seal plate slidably disposed between the top plate and the sealing surface;
a plurality of guide pins extending between the sealing surface and the top plate, wherein the seal plate is configured to slide along the plurality of guide pins between a closed position and an open position when subject to a pressure exceeding a threshold pressure;
a plurality of springs disposed between the sealing surface and the top plate and adapted to bias the seal plate into the closed position.

10. The pressure release valve of claim 9, wherein the threshold pressure is from approximately 60 psi to approximately 100 psi.

11. The pressure release valve of claim 9, further comprising a spark arrestor coupled to the sealing surface.

12. The pressure release valve of claim 9, wherein the sealing surface is on a base plate coupled to the intake manifold.

13. The pressure release valve of claim 12, further comprising:
a plurality of fasteners fastening the base plate to the intake manifold;
a plurality of notches in the top plate; and
a plurality of notches in the base plate aligned with the plurality of notches in the top plate and aligned with the plurality of fasteners of the base plate.

14. The pressure release valve of claim 9, further comprising an outer gasket defining the sealing surface.

15. The pressure release valve of claim 9, further comprising a plurality of fasteners configured to couple the sealing surface to the intake manifold, wherein the plurality of fasteners are angularly offset from the plurality of guide pins.

16. A pressure release valve configured to vent excess pressure from an intake manifold of an internal combustion engine, the pressure release valve comprising:
a base plate configured to be coupled to the intake manifold;
a top plate coupled to and spaced from the base plate;
a seal plate slidably disposed between the top plate and the base plate, wherein the seal plate is configured to move between a closed position and an open position when subject to a pressure exceeding a threshold pressure; and
at least one resilient member disposed between the base plate and the top plate and adapted to bias the seal plate into the closed position.

17. The pressure release valve of claim 16, wherein the threshold pressure is from approximately 60 psi to approximately 100 psi.

18. The pressure release valve of claim 16, further comprising a spark arrestor coupled to the base plate.

19. The pressure release valve of claim 16, wherein the at least one resilient member comprises a plurality of springs.

20. An internal combustion engine comprising an intake manifold and the pressure release valve of claim 16.
